(19) United States
(12) Patent Application Publication
(10) Pub. No.: US 2020/0300036 A1
(43) Pub. Date: Sep. 24, 2020

(54) CONTROL DEVICE FOR CURTAIN LIFTING

(71) Applicant: NINGBO LIYANG NEW MATERIAL COMPANY LIMITED, NINGBO (CN)

(72) Inventors: BAOGUO TAN, NINGBO (CN); BAOWEN TAN, NINGBO (CN)

(73) Assignee: NINGBO LIYANG NEW MATERIAL COMPANY LIMITED

(21) Appl. No.: 16/807,516

(22) Filed: Mar. 3, 2020

(30) Foreign Application Priority Data
Mar. 18, 2019 (CN) 201920343800.1

(51) Int. Cl. E06B 9/68; E06B 9/323; E06B 9/322

(52) U.S. Cl. CPC E06B 9/68; E06B 9/323; E06B 2009/689; E06B 2009/3222; E06B 9/322

(57) ABSTRACT

The present disclosure discloses a control device for curtain lifting, comprising a housing, the housing is internally provided with a first chamber for containing a power unit and a second chamber for containing a drive unit; by the arrangement of the first and second chambers in this disclosure, both the power unit and the drive unit are received within the housing, and the power unit that should have been exposed is compactly disposed in the housing, therefore, the structure is simple and neat, with improved appeal and enhanced safety.

### CROSS-REFERENCE TO RELATED APPLICATIONS

This application claims priority to Chinese Patent Application No. 201920343800.1 with a filing date of Mar. 18, 2019. The content of the aforementioned applications, including any intervening amendments thereto, are incorporated herein by reference.

### TECHNICAL FIELD

The present disclosure relates to the technical field of curtain accessories, in particular to a control device for curtain lifting.

### BACKGROUND

A shutter curtain is normally mounted at the upper end of a window through an ejector rod, and is manually opened or closed through a pull cord or a pull rod. Generally speaking, most of the traditional curtains are opened or closed manually, making it laborious to operate, and the operation must be accomplished beside the curtain; thus, the existing curtains tend to develop into an electrically-driven type, and can be opened or closed by a remote control at a location away from the curtain, making it more labor-saving and convenient. To be specific, the remote control transmits a signal to a control device which is mounted on the ejector rod of the curtain and comprises a housing, a drive unit, a power unit, a control unit, a circuit board and the like; the circuit board is provided with an antenna for receiving a signal from the remote control; the signal received by the antenna is fed back to the control unit, and the control unit instructs the drive unit to act so as to open or close the curtain. However, in the structure of the existing shutter curtain, the ejector rod with a narrow inner cavity, provides limited space for the control device since a pull cord assembly in the ejector rod has already occupied a large space; in such a case, the power unit of the control device is often exposed outside the control device and the ejector rod, i.e., the power unit is suspended outside the ejector rod and exposed, which is neither appealing nor safe.

### SUMMARY

One objective of the present disclosure is to overcome the shortcomings of the prior arts by providing a control device for curtain lifting that a power unit can be received within the housing thereof, with compact structure and enhanced safety.

The technical solution of the present disclosure is as follows: a control device for curtain lifting, comprising a housing, the housing is internally provided with a first chamber for containing a power unit and a second chamber for containing a drive unit.

In some embodiment, the housing is also internally provided with a control unit for controlling the drive unit to act, and the control unit is electrically connected with the power unit.

In some embodiment, the housing has a seal cover at its end; the seal cover is internally provided with a circuit board, and the circuit board and the control unit are in FPC connection.

In some embodiment, a power switch is mounted on the circuit board, a seal plate covering the circuit board is arranged on the seal cover, and the power switch is exposed on the surface of the seal plate.

In some embodiment, the circuit board is also provided with an indicator light, a SETUP key, a charging interface and an antenna for receiving signals from the remote control. In some embodiment, the first chamber is arranged above the second chamber.

In some embodiment, a clamping portion connected with the ejector rod of the curtain is arranged at the external side of the housing.

Compared with the prior art, the control device for curtain lifting disclosed by the present disclosure has the advantages that by the arrangement of the first and second chambers, both the power unit and the drive unit are received within the housing, and the power unit that should have been exposed is compactly disposed in the housing, therefore, the structure is simple and neat, with improved appeal and enhanced safety.

### BRIEF DESCRIPTION OF THE DRAWINGS

FIG. 1 is an exploded view of the present disclosure.

FIG. 2 is a schematically structural diagram of the present disclosure.

FIG. 3 is a schematically mounting diagram of the present disclosure.

The reference numerals denote that: 1 housing; 2 the first chamber; 3 the second chamber; 4 power unit; 5 drive unit; 6 seal cover; 7 circuit board; 8 control unit; 9 power switch; 10 seal plate; 11 indicator light; 12 SETUP key; 13 charging interface; 14 antenna; 15 clamping portion; 16 light-guiding column; 17 ejector rod; 18 FPC interface.

### EMBODIMENTS

The illustrative embodiment herein will be described below using terms commonly employed by those skilled in the art to convey the substance of their work to others skilled in the art. However, it will be apparent to those skilled in the art that alternate embodiments may be practiced with only some of the described aspects. For purposes of explanation, specific numbers, material and configuration are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having” and “including” are synonymous, unless the context dictates otherwise.

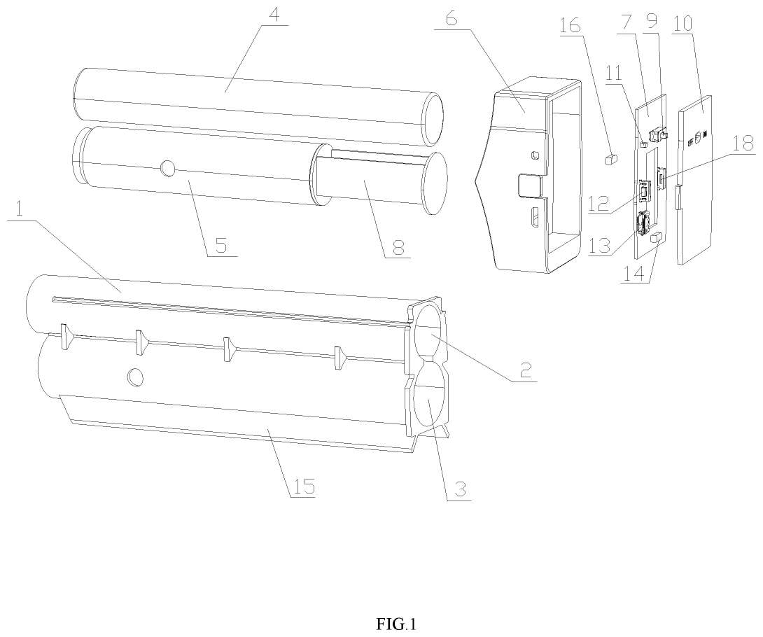

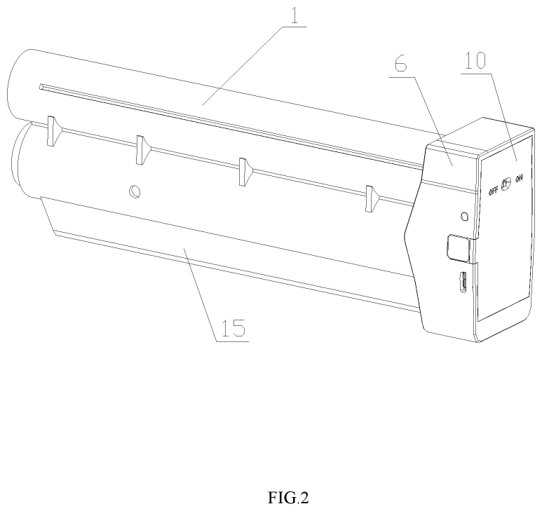

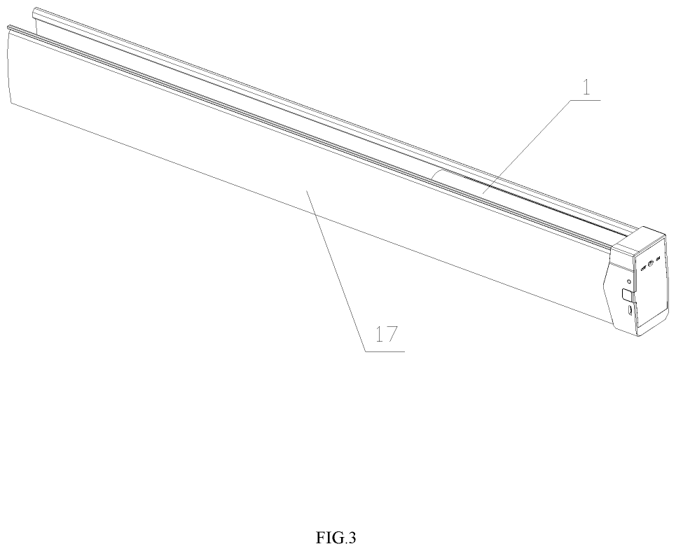

As shown in FIGS. 1-3, a control device for curtain lifting, comprises a housing 1; the housing 1 is internally provided with a first chamber 2 for receiving a power unit 4 and a second chamber 3 for receiving a drive unit 5, preferably, the power unit 4 is a lithium battery; the drive unit 5 comprises a motor and a deceleration mechanism that are connected to each other; the output shaft of the deceleration mechanism extends out of the housing 1 to be connected with a pull cord mechanism of a curtain so as to control opening or closing of the curtain.

The first chamber 2 and second chamber 3 in the present disclosure enables the storage of the power unit 4 and the drive unit 5 within the housing 1, and the power unit 4 that should have been exposed is compactly disposed in the housing 1, therefore, the structure is simple and neat, with improved appeal and enhanced safety.

The housing 1 is also internally provided with a control unit 8 for controlling the drive unit 5 to act. The control unit 8 is electrically connected with the power unit 4. The housing 1 has a seal cover 6 at its end. The seal cover 6 is internally provided with a circuit board 7; the circuit board 7 and the control unit 8 are in FPC connection. The circuit board 7 has a FPC interface 18 for FPC connection. The circuit board 7 is also provided with a power switch 9 thereon. The seal cover 6 is provided with a seal plate 10 covering the circuit board 7. The power switch 9 is exposed on the surface of the seal plate 10. With the arrangement of the power switch 9, it is convenient for people to switch on or off a power supply, thereby saving electricity. The control device is often warehoused after production, so if the power supply is on, the control unit 8 enters a standby state, in such a case, electricity in the power supply is consumed and then will be exhausted prior to sale. Owing to the added power switch 9, the control device is always under an off state during the storing and transporting processes so as to maintain the electricity quantity, and the power supply is switched on after sale and assembly so as to ensure normal operation of the control device. The circuit board 7 is further provided with an indicator light 11, a SETUP key 12, a charging interface 13 and an antenna 14 for receiving a signal from the remote control. Lamplight from the indicator light 11 is guided out of the seal cover 6 through the light-guiding column 16 for people to discern that the control device is under a working state. It is convenient for people to debug since the drive unit 5 is can be debugged manually through the SETUP key 12. The charging interface 13 can be connected with a charging wire to charge the power unit 4. The antenna 14 is arranged in the seal cover 6 so that the control device looks more appealing and the external structure neat and tidy.

The first chamber 2 is arranged above the second chamber 3, in this way, the power unit 4 is contained within the housing 1 while ensuring that the housing 1 is not lengthened so as to prevent the control device from hindering other elements in the ejector rod 17.

A clamping portion 15 connected with the ejector rod 17 of the curtain is arranged at the external side of the housing 1. Preferably, there are two clamping portions 15 at the bottom of the housing 1 in bilateral symmetry so as to play a limiting role when the control device and the ejector rod 17 are in inserted connection, thus preventing the control device from sliding left and right in the ejector rod 17.

When in use, the assembled control device is inserted into the ejector rod 17, the output shaft of the drive unit 5 is connected with the pull cord mechanism of the curtain, the remote control transmits the signal to the antenna 14, the antenna 14 forwards the received signal to the control unit 8, and the control unit 8 controls the drive unit 5 to act so as to pull the curtain to be opened or closed and achieve the electric control of the curtain.

It should be noted that, the above embodiments are merely illustrative, rather than restrictive, to the technical solutions of the present disclosure. Although the present disclosure has been explained in detail by referring to the above-mentioned embodiments, it should be understood by those skilled in the art that, modifications to the technical solutions in the embodiments or equivalent substitutions of portion of technical features are allowed. These modifications or substitutions shall not cause the corresponding technical solutions to depart from the spirit and scope of the technical solutions of the embodiments of the present disclosure.

I claim:

1. A control device for curtain lifting, comprising a housing wherein the housing is internally provided with a first chamber for containing a power unit and a second chamber for containing a drive unit.

2. The control device for curtain lifting of claim 1, wherein the housing is also internally provided with a control unit for controlling the drive unit to act, and the control unit is electrically connected with the power unit.

3. The control device for curtain lifting of claim 2, wherein the housing has a seal cover at its end; the seal cover is internally provided with a circuit board, and the circuit board and the control unit are in FPC connection.

4. The control device for curtain lifting of claim 3, wherein a power switch is mounted on the circuit board, a seal plate covering the circuit board is arranged on the seal cover, and the power switch is exposed on the surface of the seal plate.

5. The control device for curtain lifting of claim 4, wherein the circuit board is also provided with an indicator light, a SETUP key, a charging interface and an antenna for receiving signals from the remote control.

6. The control device for curtain lifting of claim 1, wherein the first chamber is arranged above the second chamber.

7. The control device for curtain lifting of claim 1, wherein a clamping portion connected with the ejector rod of the curtain is arranged at the external side of the housing.
